(19) United States
(12) Patent Application Publication
(10) Pub. No.: US 2026/0326865 A1
(43) Pub. Date: Oct. 22, 2026

(54) OFF-SHORE FLOATING PLATFORM FOR FLOATING WIND TURBINE MANUFACTURE, ASSEMBLY, MAINTENANCE AND/OR DISASSEMBLY

(71) Applicant: SAFIER INGENIERIE, Serris (FR)

(72) Inventor: Elchanan SAFIER, Crecy La Chapelle (FR)

(73) Assignee: SAFIER INGENIERIE, Serris (FR)

(21) Appl. No.: 19/114,051

(22) PCT Filed: Sep. 15, 2023
(86) PCT No.: PCT/FR2023/051411

§ 371 Date: Mar. 21, 2025

(30) Foreign Application Priority Data
Sep. 27, 2022 (FR) FR2209795

(51) Int. Cl. B63B 75/00; B63B 5/14; B63B 21/50; B63B 27/12; B63B 35/44; F03D 13/25

(52) U.S. Cl. CPC B63B 75/00; B63B 5/14; B63B 21/50; B63B 27/12; B63B 35/44; F03D 13/256; B63B 2035/446; F05B 2230/6102; F05B 2230/70; F05B 2240/93; F05B 2240/95

(57) ABSTRACT

A floating off-shore platform configured for the offshore manufacture and/or assembly and/or maintenance and/or disassembly of floating wind turbines includes: a floating foundation, a mast, a nacelle, at least one blade, a first zone dedicated to the manufacture of the floating foundation configured to receive the mast, a second zone dedicated to the assembly and/or disassembly of the floating foundation and the mast, and a third zone equipped with an at least partially submersible lifting platform, the platform being composed of a plurality of monolithic floating caissons.

The present invention relates to the field of floating wind turbines, and more particularly to the manufacture, assembly, maintenance and/or disassembly in series of a floating foundation and its wind turbine or turbines, the whole being carried out on water, floating.

The wind turbines are devices that generate electricity from the kinetic energy of the wind. The floating foundation acts as the foundation of the wind turbine, providing a stable base to hold the wind turbine in deep water, in places where foundations attached in the ground are not economically and/or technically feasible. The wind turbines generally are composed of one or more masts, at the top of which is a turbine and one or more blades, these blades are driven by the wind so as to provide the turbine with kinetic energy. To make the best use of the energy of the wind, the wind turbines may be floating wind turbines or off-shore, meaning that they are installed off-shore where the winds are generally stronger and more regular than on-shore.

Floating wind turbines are usually built on-shore, for example in on-shore port factories, then transported to areas of interest and installed on the seabed. The floating wind turbines may then be returned to land for maintenance or when they need to be dismantled.

The construction of the floating wind turbines does, however, pose major logistical problems, including the need to occupy large areas of land, to provide special facilities and handling equipment, and to obtain construction and environmental permits to allow the storage and movement on the ground of structures weighing thousands of tones, as well as to allow the floating wind turbine to be launched or the wind turbine to be assembled at height on its floating foundation.

The present invention aims to overcome this disadvantage by proposing an anchored floating platform equipped with a manufacturing and assembly line for floating wind turbines off-shore, which thus aims to allow floating wind turbines to be manufactured directly on the water. A platform of this kind allows to reduce logistical requirements, and therefore costs, and saves time because it is not necessary to bring floating wind turbines back to land, particularly during maintenance operations, as onshore and port infrastructures are not required. The platform also reduces the carbon footprint resulting from the movement of the floating wind turbines.

The main object of the present invention is thus a floating off-shore platform configured for the off-shore manufacture and/or assembly and/or maintenance and/or disassembly of floating wind turbines comprising a floating foundation, at least one mast, at least one nacelle and at least one blade, the platform comprising at least one first area dedicated to the manufacture of the floating foundation configured to receive the mast and at least one second area dedicated to the assembly and/or maintenance and/or disassembly of the floating foundation and the mast, and a third area equipped with an at least partially submersible lifting platform, the platform being composed of a plurality of floating caissons.

The platform according to the invention is an offshore platform, i.e. it is configured to be installed off-shore; in other words, the manufacture, assembly, maintenance or disassembly of the floating wind turbines for which it is used may be carried out off-shore. The platform is mobile for this purpose, so it may be moved from one point of interest to another. It is composed of several floating caissons, which are modular caissons associated with each other, allowing a modularity in the shape of the platform, so as to adapt to the needs of manufacturing, assembly, maintenance and disassembly operations. The shape of the platform is not subject to any restrictions, thanks to its modularity and the combination of these caissons.

The floating wind turbines are composed of a mast, sometimes several masts, at one end of which is a nacelle comprising a turbine, sometimes several turbines, and one or more blades, and a floating foundation configured to ensure the stability of the mast and the elements it supports in the water. The platform comprises at least one first manufacturing area for this floating foundation. More specifically, the various parts making up the floating foundation are assembled.

The first area comprises means for assembling structural elements of the floating foundation. The first area comprises columns, floats, braces interconnecting these floats, gateways of the floating structure, means for securing the columns and the gateways, and secondary and tertiary structures of the floating structure. The first area also comprises means for assembling the mast, nacelle and blades together, as well as all the other elements of the floating wind turbine, such as ballasting systems for the floating structure. The manufacture is done as a serial production, i.e. the platform may be used to produce a number of floating foundations.

The platform also comprises at least one second area wherein the floating foundation is assembled to the mast or wherein these two elements are disassembled. The second area also comprises means for assembling the mast, the nacelle and the blades to the floating structure. The second area comprises the tools needed to assemble the mast, the nacelle and the blades to the floating structure, as well as elements for securing the mast to the floating structure. This second area may also be used for the assembly or, conversely, the disassembly of the mast, the turbine and the blades, as well as all the commissioning operations prior to the installation of the floating wind turbine. Thanks to these two types of area, it is possible to produce floating wind turbines directly off-shore, ready to be installed and used. This reduces the constraints associated with moving these floating wind turbines when they are built on land and then transported off-shore.

According to one characteristic, the platform is anchored. Such anchoring may be temporary or permanent. Such a platform thus comprises anchoring means configured to immobilize the platform off-shore or means for mooring said platform.

The mooring and/or anchoring system is configured to maintain a temporary or permanent geostationary floating position for the platform.

Such a mooring and/or seabed anchoring system comprises mooring lines, anchors and connectors, and allows the platform to be temporarily or permanently connected to the seabed to prevent it from drifting. The mooring and/or anchoring system also allows the platform to be moved on the water.

According to one characteristic, the platform is configured to allow the manufacture and/or assembly and/or maintenance and/or disassembly of floating wind turbines of different sizes

According to a characteristic of the invention, the platform comprises a median portion extending mainly longitudinally and comprising the first area, and a peripheral portion comprising the second area.

This means that the floating foundations are manufactured in the center of the platform, while the wind turbine is assembled on its foundation at its periphery, i.e. on either side of the median portion and directly in the water. The first area is therefore at the heart of the platform.

According to another characteristic of the invention, the platform comprises three first areas dedicated to the manufacture of the floating foundation arranged in the median portion.

The first three areas are aligned one after the other in a longitudinal direction. Each is dedicated to a particular operation in the manufacture of floating foundations, and together they form a continuous production line within the middle portion.

According to a characteristic of the invention, the platform comprises a lifting gantry configured to move along the median portion, this lifting gantry cooperating with a guidance system on the ground.

This lifting gantry is more specifically a crane. It may be moved along the median portion in the longitudinal direction, i.e. from one area to another. For this purpose, the lifting gantry cooperates with a ground guidance system, such as a rail system, and allows the movement of elements to be assembled or assembled elements.

According to one characteristic, the platform comprises a third area equipped with an at least partially submersible lifting platform.

The lifting platform is a lift. It allows floating foundations to be launched and lifted out of the water. More specifically, the third area allows the floating foundations to be launched once they have been manufactured, and allows the floating foundations or even the floating wind turbines to be lifted out of the water for maintenance or disassembly operations, for example. Such a lifting platform is at least partially submersible in that it has housings that may be filled with water so as to act as ballast.

According to one characteristic, the third area comprising the lifting platform is configured, like the first area, for manufacturing the floating foundation and/or it is configured, like the second area, for assembling and/or maintaining and/or disassembling the floating foundation and the mast.

According to another characteristic of the invention, the third area is disposed at a longitudinal end of the median portion.

The median portion, which extends mainly longitudinally, has a first longitudinal end and a second longitudinal end. The third area is located at one of these longitudinal ends, for example the first longitudinal end. This has the effect of limiting the movement of floating foundations once they are in the water. The arrangement at one longitudinal end means that the floating foundations may be routed just as easily to either side of the median portion, i.e. to any point on the peripheral portion.

According to one characteristic, the platform comprises at least a fourth area dedicated to maintenance operations on the floating wind turbine.

This fourth area is located in the peripheral portion. It allows the maintenance and repair of the floating foundations or other elements of floating wind turbines, without the need to bring the wind turbines back to land. The fourth area comprises replacement parts for the floating wind turbine and repair equipment.

In addition or alternatively, the elements constituting the floating wind turbines may be those of the floating foundations.

According to one characteristic of the invention, the platform comprises at least a fifth area dedicated to supplying, storing and/or loading elements of the platform.

The fifth area is an area for mooring and/or berthing ships, these ships helping to supply material of the platform by loading or unloading their cargo. The fifth area comprises parking locations and mooring means for barges and ships.

According to a further characteristic, the fifth area is disposed at a longitudinal end of the median portion opposite the longitudinal end which comprises the third area.

For example, the fifth area is located at the second longitudinal end. As with the position of the third area, the disposition of the fifth area allows an easy loading and/or unloading from either side of the platform.

According to one characteristic, the first area, the third area and the fifth area are arranged in the median portion, the first area being between the third area and the fifth area in a longitudinal direction.

The first area is therefore at the center of the median portion, in relation to its longitudinal ends, which are occupied by the third area and the fifth area respectively.

According to one characteristic, the second area and the fourth area are arranged in the peripheral portion.

One characteristic of the invention is that the floating caissons are at least partially composed of concrete and comprise steel reinforcements.

The caissons comprise transverse walls, longitudinal walls and a concrete bottom, but are hollow so that they may float. The caissons also have reinforcements made of steel or an alloy of steel and one or more other materials.

In some embodiments, the floating caissons are cross-shaped when viewed from above. They are then formed by a first portion and a second portion arranged perpendicular to each other, the first portion of each of the floating caissons being aligned along the longitudinal direction. The second portion is the same size as or smaller than the first portion. The first portion of a caisson may be 80 meters+/−20% long, while the second portion of said caisson may be 45 meters+/−20% long.

In the embodiments wherein the floating caissons are cross-shaped, when they are assembled together, empty spaces remain between the floating caissons because of their shape. In order to be able to use the floating platform for manufacturing and/or assembly and/or maintenance and/or disassembly operations of the floating wind turbines, the floating caissons are covered by a floor so as to cover the empty spaces and the floating caissons.

In one characteristic, the floating caissons are interconnected by a rigid connection system so as to form a monolithic floating platform.

The invention also relates to a method for manufacturing floating wind turbines on a platform as mentioned above, the manufacturing method taking place off-shore and comprising a step of manufacturing at least one floating foundation within the first area and a step of assembling the floating foundation and the mast of the floating wind turbine within the second area.

The manufacturing step involves the first area or areas of the median portion, while the assembly step takes place within the peripheral portion and more particularly the second area. It is understood that the manufacturing step necessarily occurs prior to the assembly step, since it is necessary to produce the floating foundations so as to associate them with the masts.

According to another characteristic, the manufacturing method comprises a step of supplying structural elements of the floating wind turbine by means of the fifth area prior to the manufacturing step, and a step of launching the floating foundation by means of the lifting platform of the third area, this launching step taking place between the manufacturing step and the assembly step.

The supply step comprises barges and/or ships unloading structural elements of the floating wind turbines onto the platform, and possibly storing them on the platform. The floating foundation resulting from the assembly of these structural elements within the first area is then launched by the lifting platform in the third area and transported to the second area for assembly. The mast is thus positioned when the floating foundation on which it is placed is in the water.

The invention also relates to a method for disassembling floating wind turbines off-shore on a platform as mentioned above, the disassembling method taking place off-shore and comprising a step of disassembling at least the mast of the floating wind turbine within the sixth area, a step of lifting out of the water within the third area, a step of disassembling the floating foundation within the first area and a loading step within the fifth area.

It is understood that the disassembling step allows the mast to be detached from the floating foundation. It may also cover the disassembling of the mast in relation to the blades or a nacelle of the floating wind turbine. The step of lifting out of the water comes by means of the lifting platform in the third area. Lastly, the loading step involves loading and storing the structural elements of the floating wind turbines, which have been disassembled beforehand, on barges or ships, with such a loading step taking place in the fifth area.

The disassembling step involves loading barges and/or ships onto the platform to recover the structural elements of the floating wind turbines, and storing them on the platform if necessary.

Other characteristics, details and advantages of the invention will become clearer on reading the following description, on the one hand, and examples of embodiments given by way of indication and non-limitation with reference to the attached drawings, on the other hand, wherein:

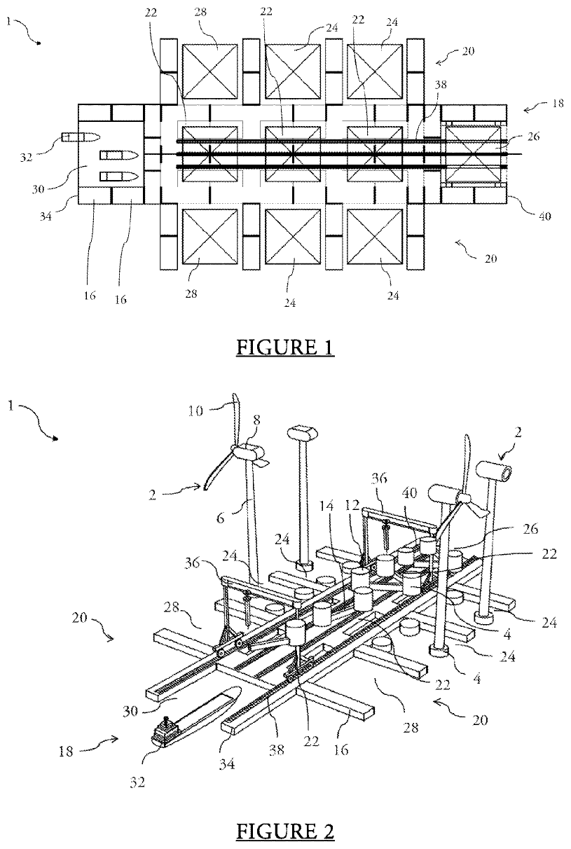

FIG. 1 schematically illustrates a plan of the platform according to the invention as seen from above;

FIG. 2 is a perspective view representation of the platform shown in FIG. 1;

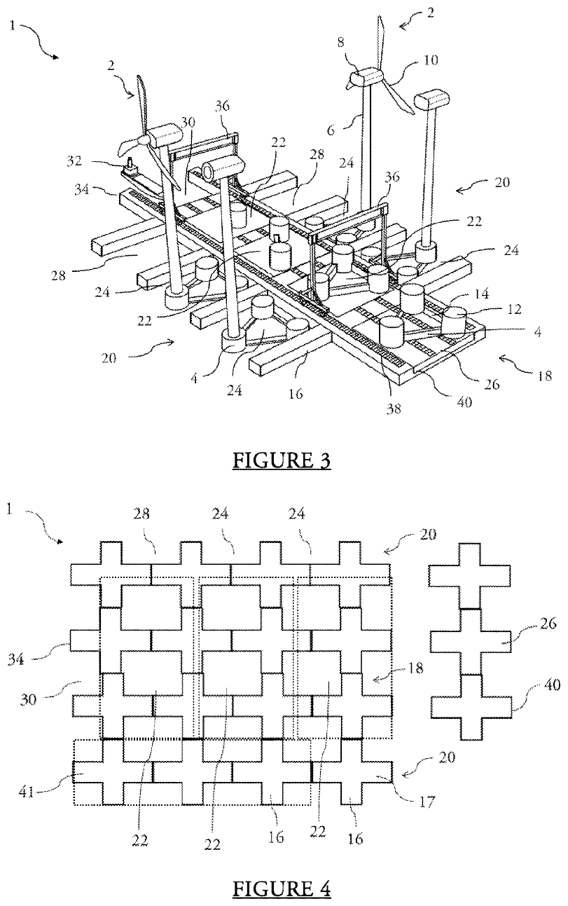

FIG. 3 is another perspective view of the platform shown in FIG. 1;

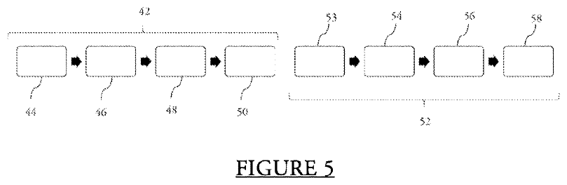

FIG. 4 is an alternative representation of FIG. 1;

FIG. 5 schematically illustrates a method for manufacturing off-shore floating wind turbines on the platform shown in FIG. 1.

The characteristics, variants and different embodiments of the invention may be associated with one another in various combinations, insofar as they are not incompatible or mutually exclusive. In particular, it will be possible to imagine variants of the invention comprising only a selection of characteristics described hereinafter in isolation from the other characteristics described, if this selection of characteristics is sufficient to confer a technical advantage and/or to differentiate the invention from the prior art.

In the figures, the elements common to several figures retain the same reference. FIGS. 1, 2, 3 and 4 illustrate, schematically, a floating offshore platform 1 according to the invention. FIGS. 1 and 4 are plans of this platform 1, while FIGS. 2 and 3 are perspective views. The platform 1 extends mainly in a longitudinal direction. It is configured to manufacture and/or assemble and/or disassembly floating wind turbines 2 off-shore, in particular floating wind turbines 2 made of concrete or steel. These floating wind turbines 2 may be seen in FIGS. 2 and 3 and will now be described in more detail.

A floating wind turbine 2 is made up of two main parts, including a first part corresponding to a floating foundation 4, also referred to as a floating structure, which comprises one or more floats, and a second part comprising one or more masts 6, one or more nacelles 8 and one or more blades 10. The nacelle 8 and the blades 10 are located at one free end of the mast 6. Another end of this mast 6 is placed or implanted on the floating foundation 4, which is the part of the floating wind turbine 2 that keeps at least the nacelle 8 and the blades 10 out of the water and prevents the floating wind turbine 2 from capsizing.

This floating foundation 4 is made up of three columns 12 connected together by gateways 14, the columns 12 and the gateways 14 being arranged so as to form a substantially equilateral triangle. The mast 6 is positioned on one of the three columns 12.

As mentioned above, the platform 1 is configured for the manufacture and/or assembly and/or maintenance and/or disassembly of the floating wind turbines 2. More specifically, it may be used to manufacture, assemble or disassemble floating wind turbines 1 of variable dimensions. As these manufacturing, assembly, maintenance and disassembly operations take place off-shore, the platform 1 is composed of a number of floating caissons 16 to keep it afloat. These floating caissons 16 are associated with each other in the desired shape of the platform 1. Such a combination of floating caissons 16 is illustrated in FIGS. 1 and 4. In particular, the combination of the floating caissons 16 involves a rigid connection system, so that their interconnection forms a monolithic platform 1, i.e. a single block. Each floating caisson is itself monolithic, i.e. made from a single piece of material, such as concrete.

The floating caissons 16 are at least partly made of concrete; they are substantially rectangular or cross-shaped, with transverse walls, longitudinal walls and a bottom made of concrete. The floating caissons 16 also comprise reinforcements made of steel or other materials allowing to strengthen them. These floating caissons 16 are hollow, so that they may float, and are configured so that they may be filled with water.

Cross-shaped floating caissons 16 are shown in FIG. 4, which is a variant of embodiment of the rectangular floating caissons 16 shown in FIG. 1. These cross-shaped floating caissons 16 comprise a first portion and a second portion arranged perpendicular to each other. The first portion, which extends mainly in the longitudinal direction, has a greater dimension, measured from one of its ends to the other in the longitudinal direction, of between 70 and 90 meters, while the second portion has a greater dimension, measured from one of its ends to the other in a direction perpendicular to the longitudinal direction, of between 40 and 50 meters. In one particular example, the first portion is 80 meters long and the second portion is 45 meters long.

In some embodiments, the platform 1 is equipped with a crane, such as a tower crane 17, in particular for installing the floating caissons 16. By way of example, the lifting height of such a tower crane 17 is of the order of 200 meters.

In some embodiments, the platform 1 has a length measured along the longitudinal direction of between 300 and 350 meters, and a width measured perpendicular to the longitudinal direction of between 150 and 200 meters. In one particular example, the platform 1 is 320 meters long and 160 meters wide. The platform 1 has a mass of around 250,000 tones.

In other embodiments, the platform 1 is around 1000 meters long and 500 meters wide.

The platform 1 is anchored to prevent it drifting. It comprises a system for mooring and/or for anchoring to the seabed, not shown here. This mooring and/or anchoring system comprises, for example, an anchor, a mooring line and connectors, and allows an anchoring to the seabed whatever the depth of the water wherein the platform 1 is located. The mooring and/or anchoring system is configured to maintain a geostationary floating position for the platform 1; in other words, it allows to prevent this platform 1 from moving accidentally. When it is not connected to the seabed by the mooring and/or anchoring system, the platform 1 is mobile. This means that the platform 1 may be moved or transported towards sites of interest where floating wind turbines 2 are to be installed. In some embodiments, the platform 1 is moored to a quay.

The platform 1 has a median portion 18 and a peripheral portion 20 arranged on either side of the median portion 18; in other words, the median portion 18, which extends mainly longitudinally, is flanked transversely from the peripheral portion 20 so as to be at least partially enclosed by it. The median portion 18 extends from one end of the platform 1 to the other in the longitudinal direction, while the peripheral portion has smaller longitudinal dimensions.

The median 18 and peripheral 20 portions each comprise different areas of the platform 1, which correspond to stations where different operations dedicated to the manufacture, assembly or disassembly of the floating wind turbines 2 are undertaken. The platform 1 comprises at least one first area 22 dedicated to the manufacture of the floating foundation 4, a second area 24 dedicated to the assembly of the floating foundation 4 and the mast 6, a third area 26 dedicated to the launching and lifting out of the water of the floating foundation 4, a fourth area 28 dedicated to maintenance operations on the floating wind turbine 2, and a fifth area 30 dedicated to supplying the platform 1. These different areas of the platform 1, which are all roughly square in shape, will now be described.

As may be seen in FIGS. 1 and 4, the platform 1 comprises three successive first areas 22. Each of these first areas 22 allows a specific operation in the manufacture of the floating foundation 4 to be carried out while floating; thus, as illustrated in FIGS. 2 and 3, they respectively allow a column 12 and a gateway 14 to be assembled to form a first sub-assembly, this sub-assembly to be assembled with a second column 12 to form a second sub-assembly, and finally this second sub-assembly to be assembled with a third column 12 and a second and third gateway 14 to form a completed floating foundation 4.

The first three areas 22 are arranged in the median portion 18. They form a continuous production line within this median portion 18, allowing series production of floating foundations 4.

The materials needed to manufacture the floating foundations 4 are transported to the platform 1 by barges or ships 32. These barges or ships 32 supply the platform 1 by means of the fifth area 30, where they may dock so as to unload their cargo. As will be explained later, this fifth area is also involved in the evacuation of the floating wind turbines 2 once they have been dismantled, their elements being loaded onto the barges or ships 32 for repatriation to land.

The fifth area 30 is strategically located at one longitudinal end of the median portion 18, which in this case is a first longitudinal end 34. To move the materials from the fifth area 30 where they are unloaded to the first area 22 where the floating foundations 4 are manufactured, the platform 1 is equipped with a lifting gantry 36 comprising, for example, a crane.

The lifting gantry 36 is particularly visible in FIGS. 2 and 3, where it is shown in various positions within the platform 1. The lifting gantry 36 moves in a longitudinal direction. To this end, it cooperates with a guidance system 38. This guidance system 38 is arranged on a floor of the platform 1 so as to pass right through it; it thus extends from one longitudinal end of the median portion 18 to the other. The guidance system 38 comprises more specifically an assembly of rails on which the lifting gantry 36 may slide to move.

In addition to transporting materials from the fifth area 30 to the first area 22, the lifting gantry 36 is involved in moving the floating foundations 4 partially completed within the first areas 22, as well as moving these completed floating foundations 4 to a third area 26. The guidance system 38 runs from the fifth area 30 to the third area 26.

The third area 26 is arranged at a second longitudinal end 40 of the median portion 18, i.e. at its longitudinal end opposite the first longitudinal end 34 which comprises the fifth area 30. It is thus understood that the first area or areas 22 are arranged longitudinally between this fifth area 30 and the third area 26. In some particular embodiments, as in FIG. 4, the third area 26 is a portion of the platform 1 that is detached from a main body of this platform 1, the main body comprising the first area 22 and the second area 24. In other words, the third area 26 is detached from the rest of the platform 1.

The third area 26 is configured for launching the floating foundations 4 or for lifting them out of the water. More specifically, the third area 26 allows the floating foundations 4 to be launched when they have been manufactured in the first area 22, and allows them to be lifted out of the water, for example when they need to be dismantled. The third area 26 comprises a lifting platform which is at least partially submersible, being filled and emptied with water so that it may be lowered and raised respectively within the platform 1. It is understood that filling the lifting platform and lowering it allows the floating foundations 4 to be launched, while emptying and raising it allows these floating foundations 4 to be lifted out of water. The tower crane 17 mentioned above is positioned on the lifting platform, for example, to make it easier to launch the floating wind turbines 2 or some of their elements, in particular their floating foundations 4.

To form complete floating wind turbines 2, the floating foundations 4 are transported to a second area 24 dedicated to assembling these floating foundations 4 with at least one mast 6. More generally, the second area 24 allows a floating foundation to be assembled with a mast 6, a nacelle 8 and at least one blade 10, as well as a disassembly, i.e. in particular disassembling the floating wind turbine 2 while afloat, disassembling its various items of equipment and any related operations.

The platform 1 comprises at least one second area 24, and advantageously a plurality of second areas 24. As in the embodiment shown in FIG. 1, the platform 1 comprises four second areas 24. The floating caissons 16 involved in forming the second areas 24 are connected to form a U, with the floating foundation 4 on which the mast 6 is to be placed being positioned in the water between the legs of the U. The second areas 24 are thus floating areas for the floating wind turbines 2.

The second areas 24 are arranged in the peripheral portion 20, with two second areas 24 arranged transversely on one side of the median portion 18 and two other second areas 24 arranged transversely on another side of this median portion, in a symmetrical manner. The second areas 24 are also arranged within the platform 1 so that they are closer to the second longitudinal end 40 of the median portion than to its first longitudinal end 34. Floating wind turbines 2 are shown at different stages of assembly between their floating foundations 4 and their other structural elements in FIGS. 2 and 3, with the floating wind turbines 2 in the vicinity of the second longitudinal end 40 being at a less advanced stage.

The platform 1 comprises at least a fourth area 28 dedicated to maintenance operations on the floating wind turbines 2 or their elements, such maintenance or repair operations being carried out while floating. The platform 1 has two fourth areas 28, one on each side of the median portion 18. It is thus understood that, like the second area 22, the fourth areas 28 are arranged in the peripheral portion 20. Each of these fourth areas 28 is more precisely arranged longitudinally between the first longitudinal end 34 of the median portion 18 and a second area 22.

In addition to the above-mentioned areas, the platform 1 comprises, in some embodiments, workshops and factories for the manufacture or repair of various elements of the floating wind turbines 2, as well as living quarters to accommodate operators involved in the manufacture, assembly, maintenance and disassembly of the floating wind turbines 2. If required, the platform 1 may comprise a helicopter deck 41 to facilitate the movement of operators and materials. This helicopter deck 41 comprises storage areas for equipment and aerial appliances required for the use of such a helicopter deck 41.

The platform 1 according to the invention allows the implementation of a manufacturing method 42 for manufacturing floating wind turbines 2, which will now be described in relation to FIG. 5. Such a manufacturing method 42 takes place off-shore, i.e. when the platform 1 is floating.

The manufacturing method 42 begins with a step 44 of supplying the platform 1 with the structural elements of the floating wind turbine 2, and in particular the columns 12 and gateways 14 configured to make the floating foundations, as well as the masts 6, nacelles 8, turbines and blades 10. This supply step 44 involves transporting these elements by barges or ships 32 to the fifth area 30 of the platform 1. The structural elements are then unloaded within this fifth area 30 and transported to the first area 22 for a step 46 of manufacturing at least one floating foundation 4. Such routing is facilitated by the presence of the lifting gantry 36 and the guidance system 38 on the ground.

The manufacturing step 46 consists of assembling the columns 12 and gateways 14 forming the floating foundations 4, involving each of the first three areas 22 in turn. Once the floating foundations 4 have been manufactured, they are driven by the lifting gantry 36 to the third area 26 for a launching step 48. This step of launching 48 the floating foundations 4 results in the lowering of the lifting platform in the third area 26, which for this purpose is at least partially filled with water.

When the floating foundations 4 are in the water, they are directed towards one of the second areas 24 for an assembly step 50. During this assembly step 50, the floating foundations 4 are assembled with other structural elements of the floating wind turbine 2, in particular the mast 6, the nacelle 8 and the blades 10.

The floating wind turbine 2 is then ready for operation. In some embodiments, the mast 6, the nacelle 8 and the blades 10 are assembled together in one or more first areas 22, before passing through the third area 26. In some cases, the mast 6, the nacelle 8 and the blades 10 may be assembled in any area of the platform 1.

When a floating wind turbine has to be dismantled, a disassembling method 52 is implemented on the platform 1. This disassembling method 52 is illustrated schematically in FIG. 5.

The disassembling method 52 takes place while floating, i.e. off-shore. It comprises a first disassembling step 53 which consists of disconnecting the mast 6 from the floating foundation 4, or even disassembling the mast 6 from the nacelle 8 and the blades 10. This first disassembling step 53 takes place in the second area 24. The disassembling method 52 is followed by a step of lifting out of the water 54 the floating foundation 4. In particular, the floating foundation 4 is created by raising the lifting platform in the third area 26. Once lifted out of the water, the floating foundation 4 is transported from the third area 26 to the first area 22 by the lifting gantry 36. It is disassembled there during a second disassembly step 56 which takes place within the first area 22. The disassembled elements resulting from this second disassembly step 56 may then be transported to the fifth area 30 via the lifting gantry 36. Within this fifth area 30, a loading step 58 takes place, during which the disassembled elements are loaded onto barges or ships 32 for being evacuated from the platform 1.

When the platform 1 is no longer used for the manufacture, assembly, maintenance or disassembly of the floating wind turbines 2, it may be converted into a floating residential area.

The present invention provides a floating off-shore platform on which floating wind turbines may be manufactured, assembled and/or disassembled, with such operations taking place off-shore rather than on land.

The present invention is not, however, limited to the means and configurations described and illustrated herein and extends equally to any equivalent means and configuration and to any technically operative combination of such means.

1. A floating off-shore platform configured for the off-shore manufacture and/or assembly and/or maintenance and/or disassembly of floating wind turbines comprising a floating foundation, at least one mast, at least one nacelle and at least one blade, the platform comprising at least one first area dedicated to the manufacture of the floating foundation configured to receive the mast, at least one second area dedicated to the assembly and/or maintenance and/or disassembly of the floating foundation and the mast, and a third area equipped with an at least partially submersible lifting platform, the platform being composed of a plurality of floating caissons.

2. The platform according to claim 1, comprising a mooring and/or anchoring system configured to maintain a temporary or permanent geostationary floating position of the platform.

3. The platform according to claim 1, comprising a median portion extending mainly longitudinally and comprising the first area, and a peripheral portion comprising the second area.

4. The platform according to claim 3, comprising three first areas dedicated to the manufacture of the floating foundation arranged in the median portion.

5. The platform according to claim 3, comprising a lifting gantry configured to move along the median portion, this lifting gantry cooperating with a guidance system on the ground.

6. The platform according to claim 3, wherein the third area is disposed at a longitudinal end of the median portion.

7. The platform according to claim 6, comprising at least a fourth area dedicated to maintenance operations on the floating wind turbine.

8. The platform according to claim 7, comprising at least a fifth area dedicated to supplying, storing and/or loading elements of the platform.

9. The platform according to claim 8, wherein the fifth area is disposed at a longitudinal end of the median portion opposite the longitudinal end which comprises the third area.

10. The platform according to claim 1, wherein the floating caissons are at least partially composed of concrete and comprise steel reinforcements.

11. The platform according to claim 1, wherein the floating caissons are interconnected by a rigid connection system so as to form a monolithic floating platform.

12. A method for manufacturing floating wind turbines on a platform according to claim 1, the manufacturing method taking place off-shore and comprising a step of manufacturing at least one floating foundation within the first area and a step of assembling the floating foundation and the mast of the floating wind turbine within the second area.

13. The manufacturing method according to claim 12, wherein the platform comprises a median portion extending mainly longitudinally and comprising the first area, and a peripheral portion comprising the second area, the third area is disposed at a longitudinal end of the median portion, the platform comprises at least a fourth area dedicated to maintenance operations on the floating wind turbine, and at least a fifth area dedicated to supplying. storing and/or loading elements of the platform, wherein the fifth area is disposed at a longitudinal end of the median portion opposite the longitudinal end which comprises the third area,
the method comprising a step of supplying structural elements of the floating wind turbine by means of the fifth area prior to the manufacturing step, and a step of launching the floating foundation by means of the lifting platform of the third area, this launching step taking place between the manufacturing step and the assembly step.

14. A method for disassembling floating wind turbines on a platform according to claim 9, the disassembling method taking place off-shore and comprising a step of disassembling at least the mast of the floating wind turbine within the second area, a step of lifting out of the water within the third area, a step of disassembling the floating foundation within the first area and a loading step within the fifth area.
